(19) United States
(12) Patent Application Publication
(10) Pub. No.: US 2010/0159176 A1
(43) Pub. Date: Jun. 24, 2010

(54) MISCIBLE BLENDS OF TEREPHTHALATE POLYESTERS CONTAINING 1,4-CYCLOHEXANEDIMETHANOL AND 2,2,4,4-TETRAMETHYLCYCLOBUTANE-1,3-DIOL

(75) Inventors: Wesley Raymond Hale, Kingsport, TN (US); Gary Michael Stack, Kingsport, TN (US); Michael James Keegan, Kingsport, TN (US); Fabio Bogni, Gray, TN (US)

Correspondence Address: ERIC D. MIDDLEMAS;EASTMAN CHEMICAL COMPANY, P. O. BOX 511, KINGSPORT, TN, 37662-5075, US

(73) Assignee: Eastman Chemical Company, Kingsport, TN (US)

(21) Appl. No.: 12/639,324

(22) Filed: Dec. 16, 2009

Related U.S. Application Data
(60) Provisional application No. 61/138,745, filed on Dec. 18, 2008.

(51) Int. Cl. B32B 1/08; C08L 67/00; B32B 1/02

(52) U.S. Cl. 428/36.9; 525/418; 428/35.7

(57) ABSTRACT

Disclosed are miscible, polyester blends that contain at least one first polyester comprising terephthalic acid and 1,4-cyclohexanedimethanol, and at least one second polyester comprising terephthalic acid, 2,2,4,4-tetramethyl-1,3-cyclobutanediol, and 1,4-cyclohexanedimethanol. The polyester blends have good clarity, toughness, and moldability and are useful for the preparation of shaped articles. Also disclosed are shaped articles prepared from the polyester blends.

### FIELD OF THE INVENTION

This invention pertains to blends of at least two different polyesters that are miscible. More specifically, the invention pertains to miscible blends comprising at least one first polyester comprising terephthalic acid and 1,4-cyclohexanedimethanol and at least one second polyester comprising terephthalic acid, 2,2,4,4-tetramethyl-1,3-cyclobutanediol, and 1,4-cyclohexanedimethanol.

### DETAILED DESCRIPTION

Polymer blends are mixtures of structurally different polymers or copolymers. Commercially important polymer blends are generally mechanical mixtures that are made by melt blending the various polymers in an extruder or other suitable intensive mixer. Most polymer-blend pairs form immiscible two-phase structures that are often hazy or opaque and which have properties that are inferior to those that would be predicted from combining the polymer components. Miscible polymer blends, by contrast, can provide properties that are proportional to the relative amounts of the component polymers. Miscible polymer blends, however, are rare.

Polyesters that have the degree of toughness and clarity required for many commercial applications such as, for example, molded appliance parts, frequently exhibit high melt viscosities (low melt flow) that make production of complex shaped articles difficult. Attempts to modify these polyesters by blending with other polyesters often produce immiscible blends, which lack adequate clarity, or miscible blends which do not have adequate toughness. Polyester blends with a combination of toughness, good clarity, and good moldability, therefore, are desirable. Such blends can be used for a great variety of articles because the composition and properties of the blends can be easily adjusted to meet a range of performance requirements. In addition, the manufacture of shaped articles using these blends can readily accommodate the incorporation of substantial scrap polymer or regrind that is produced during the formation of the shaped article while retaining adequate performance of the article.

We have discovered miscible blends comprising at least two, different polyesters that can have high clarity, good toughness, and good moldability. Our invention, therefore, provides a polyester blend comprising:

A. about 5 to about 95 weight percent of at least one first polyester comprising:
i. diacid residues comprising about 50 to 100 mole percent, based on the total first polyester diacid residues, of the residues of terephthalic acid and 0 to about 50 mole percent of the residues of isophthalic acid; and
ii. diol residues comprising about 70 to 100 mole percent, based on the total first polyester diol residues, of the residues of 1,4-cyclohexanedimethanol and about 0 to about 30 mole percent of the residues of ethylene glycol; and
   B. about 5 to about 95 weight percent of at least one second polyester comprising:
i. diacid residues comprising about 80 to 100 mole percent, based on the total second polyester diacid residues, of the residues of terephthalic acid; and
ii. diol residues comprising about 10 to about 50 mole percent, based on the total second polyester diol residues, of the residues of 2,2,4,4-tetramethyl-1,3-cyclobutanediol and about 50 to about 90 mole percent of the residues of 1,4-cyclohexanedimethanol;
wherein the blend exhibits a single glass transition temperature by differential scanning calorimetry.
   The polyesters of our blend are readily prepared by melt blending the first and second polyester components. The blends of the invention are useful for the preparation of various shaped articles such as, for example, sheets, films, fibers, tubes, preforms, containers, bottles, and thermoformed articles. These articles can be prepared by methods well-known in the art including, but not limited to, extrusion, calendering, thermoforming, blow-molding, extrusion blow-molding, injection molding, injection blow-molding, injection stretch blow-molding, compression molding, profile extrusion, cast extrusion, melt-spinning, drafting, tentering, or blowing.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, each numerical parameter should at least be construed in light of the number of reported significant digits and by applying ordinary rounding techniques. Further, the ranges stated in this disclosure and the claims are intended to include the entire range specifically and not just the endpoint(s). For example, a range stated to be 0 to 10 is intended to disclose all whole numbers between 0 and 10 such as, for example 1, 2, 3, 4, etc., all fractional numbers between 0 and 10, for example 1.5, 2.3, 4.57, 6.1113, etc., and the endpoints 0 and 10. Also, a range associated with chemical substituent groups such as, for example, “C₁ to C₅ hydrocarbons,” is intended to specifically include and disclose C₁ and C₅ hydrocarbons as well as C₂, C₃, and C₄ hydrocarbons.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The term “polyester,” as used herein, is intended to include “copolyesters” and is understood to mean a synthetic polymer prepared by the polycondensation of one or more difunctional carboxylic acids with one or more difunctional hydroxyl compounds. Typically the difunctional carboxylic acid is a dicarboxylic acid and the difunctional hydroxyl compound is a dihydric alcohol such as, for example, glycols and diols. The term “residue,” as used herein, means any organic structure incorporated into a polymer or plasticizer through a polycondensation reaction involving the corresponding monomer. The term “repeating unit,” as used herein, means an organic structure having a dicarboxylic acid residue and a diol residue bonded through a carbonyloxy group. Thus, the dicarboxylic acid residues may be derived from a dicarboxylic acid monomer or its associated acid halides, esters, salts, anhydrides, or mixtures thereof. As used herein, therefore, the term dicarboxylic acid is intended to include dicarboxylic acids and any derivative of a dicarboxylic acid, including its associated acid halides, esters, half-esters, salts, half-salts, anhydrides, mixed anhydrides, or mixtures thereof, useful in a polycondensation process with a diol to make high molecular weight polyester.

The polymer blends of present invention include at least two or more polyesters comprising dicarboxylic acid residues, diol residues, and, optionally, branching monomer residues. The polyesters included in the present invention contain substantially equal molar proportions of diacid residues (100 mole percent) and diol residues (100 mole percent) which react in substantially equal proportions such that the total moles of repeating units is equal to 100 mole percent. The mole percentages provided in the present disclosure, therefore, may be based on the total moles of diacid residues, the total moles of diol residues, or the total moles of repeating units. For example, a polyester containing 20 mole percent isophthalic acid, based on the total diacid residues, means the polyester contains 20 mole percent isophthalic acid residues out of a total of 100 mole percent diacid residues. Thus, there are 20 moles of isophthalic acid residues among every 100 moles of diacid residues. In another example, polyester containing 80 mole percent 1,4-cyclohexanedimethanol residues, based on the total diol residues, means the polyester contains 80 mole percent 1,4-cyclohexanedimethanol residues out of a total of 100 mole percent diol residues. Thus, there are 80 moles of 1,4-cyclohexanedimethanol residues among every 100 moles of diol residues.

Whenever the term “inherent viscosity” (abbreviated herein as “IV”) is used in this application, it will be understood to refer to viscosity determinations made at 25° C. using 0.5 grams of polymer per 100 mL of a solvent comprising 60 weight percent phenol and 40 weight percent tetrachloroethane.

The polyester blends of the present invention comprise at least one first polyester and at least one, different, second polyester. The term “polyester blend,” as used herein, is intended to mean a physical blend of at least 2 different polyesters. Typically, polyester blends are formed by blending the polyester components in the melt phase. The polyester blends of the present invention are miscible or homogeneous blends. The term “homogeneous blend,” as used herein, is synonymous with the term “miscible,” and is intended to mean that the blend has a single, homogeneous phase as indicated by a single, composition-dependent glass transition temperature (abbreviated herein as “Tg”) as determined by differential scanning calorimetry. By contrast, the term “immiscible” denotes a blend that shows at least 2, randomly mixed phases and exhibits more than one Tg. A further general description of miscible and immiscible polymer blends and the various analytical techniques for their characterization may be found in Polymer Blends Volumes 1 and 2, Edited by D. R. Paul and C. B. Bucknall, 2000, John Wiley & Sons, Inc.

The first polyester (A) of our polyester blend comprises diacid residues comprising about 50 to 100 mole percent, based on the total first polyester diacid residues, of the residues of terephthalic acid and about 0 to 50 mole percent of the residues of isophthalic acid. For example, the diacid residues of the first polyester may comprise about 60 to 100 mole percent of the residues of terephthalic acid and about 0 to about 40 mole percent of the residues of isophthalic acid. Some additional examples of the diacid residues in the first polyester (A) are about 65 to about 100 mole percent of the residues of terephthalic acid and about 0 to about 35 mole percent of the residues of isophthalic acid, about 70 to about 100 mole percent of the residues of terephthalic acid and about 0 to about 30 mole percent of the residues of isophthalic acid, about 75 to about 100 mole percent of the residues of terephthalic acid and about 0 to about 25 mole percent of the residues of isophthalic acid, about 80 to about 100 mole percent of the residues of terephthalic acid and about 0 to about 20 mole percent of the residues of isophthalic acid, about 90 to about 100 mole percent of the residues of terephthalic acid and about 0 to about 10 mole percent of the residues of isophthalic acid, and about 95 to about 100 mole percent of the residues of terephthalic acid and about 0 to about 5 mole percent of the residues of isophthalic acid.

The diacid residues of the first polyester may further comprise from 0 to about 20 mole percent of the residues of a modifying dicarboxylic acid containing 4 to 40 carbon atoms if desired. In one embodiment, the modifying dicarboxylic acid can comprise aromatic dicarboxylic acids, other than terephthalic or isophthalic acids, containing 8 to about 16 carbon atoms, cycloaliphatic dicarboxylic acids containing 8 to about 16 carbon atoms, acyclic dicarboxylic acids containing about 2 to about 16 carbon atoms, or mixtures thereof. For example, the first polyester may comprise 0 to about 20 mole percent of the residues of a modifying dicarboxylic acid selected from malonic acid, succinic acid, glutaric acid, 1,3-cyclohexanedicarboxylic, 1,4-cyclohexanedicarboxylic acid, adipic acid, oxalic acid, suberic acid, sebacic acid, azelaic acid, dimer acid, pimelic acid, dodecanedioic acid, sulfoisophthalic acid, 2,6-decahydronaphthalenedicarboxylic acid, 4,4′-oxybenzoic acid, 3,3′- and 4,4′-stilbenedicarboxylic acid, 4,4′-dibenzyldicarboxylic acid, 1,4-, 1,5-, 2,3-, 2,6, and 2,7-naphthalenedicarboxylic acids, and combinations thereof. Where cis and trans isomers are possible, the pure cis or trans or a mixture of cis and trans isomers may be used.

The first polyester also comprises diol residues comprising about 70 to 100 mole percent, based on the total first polyester diol residues, of the residues of 1,4-cyclohexanedimethanol (abbreviated herein as “1,4-CHDM”) and about 0 to about 30 mole percent of the residues of ethylene glycol. Some additional examples of diol residues in the first polyester are about 75 to about 100 mole percent 1,4-CHDM and 0 to about 25 mole percent ethylene glycol, about 80 to about 100 mole percent 1,4-CHDM and 0 to about 20 mole percent ethylene glycol, about 85 to about 100 mole percent 1,4-CHDM and 0 to about 15 mole percent ethylene glycol, about 90 to about 100 mole percent 1,4-CHDM and 0 to about 10 mole percent ethylene glycol, and about 95 to about 100 mole percent 1,4-CHDM and 0 to about 5 mole percent ethylene glycol. In addition to 1,4-CHDM and ethylene glycol, the diol residues may comprise from 0 to about 10 mole percent of the residues of at least one modifying glycol. Examples of modifying glycols include, but are not limited to, propylene glycol, 1,3-propanediol, 2,4-dimethyl-2-ethylhexane-1,3-diol, 2,2-dimethyl-1,3-propanediol, diethylene glycol, 2-ethyl-2-butyl-1,3-propanediol, 2-ethyl-2-isobutyl-1,3-propanediol, 1,3-butanediol, 1,4-butanediol, neopentyl glycol, 1,5-pentanediol, 1,6-hexanediol, 1,8-octanediol, 2,2,4-trimethyl-1,6-hexanediol, thiodiethanol, 1,2-cyclohexanedimethanol, 1,3-cyclohexanedimethanol, polyethylene glycol, diethylene glycol, polytetramethylene glycol, 2,2,4,4-tetramethyl-1,3-cyclobutanediol, and combinations thereof.

As noted above, cycloaliphatic diols may be present as their pure cis or trans isomers or as a mixture of cis and trans isomers. For example, 1,4-cyclohexanedimethanol may have a cis:trans molar ratio of about 60:40 to about 40:60. Other examples of cis:trans ratios are about 70:30 to about 30:70 and about 80:20 to about 20:80. In another embodiment, the trans 1,4-cyclohexanedimethanol can be present in an amount of 60 to 80 mole percent and the cis 1,4-cyclohexanedimethanol can be present in an amount of 20 to 40 mole percent wherein the total percentages of cis 1,4-cyclohexanedimethanol and trans 1,4-cyclohexanedimethanol is equal to 100 mole percent. For example, the first polyester may comprise about 60 mole percent trans 1,4-cyclohexanedimethanol and about 40 mole percent cis 1,4-cyclohexanedimethanol. In another example, the first polyester may comprise about 70 mole percent trans 1,4-cyclohexanedimethanol and about 30 mole percent cis 1,4-cyclohexanedimethanol.

In one example, the first polyester can comprise diacid residues comprising about 95 to 100 mole percent of the residues of terephthalic acid and 0 to about 5 mole percent of the residues of isophthalic acid, and diol residues comprising about 80 to about 100 mole percent of 1,4-cyclohexanedimethanol and about 0 to about 20 mole percent of the residues of ethylene glycol. In another example, the first polyester of our novel blend can comprise diacid residues comprising about 60 to about 70 mole percent of the residues of terephthalic acid and about 30 to about 40 percent of the residues of isophthalic acid and diol residues comprising about 95 to about 100 mole percent of the residues of 1,4-cyclohexanedimethanol. Any remaining diol content can comprise ethylene glycol or a modifying glycol.

The polyester blend also comprises a second polyester (B) which can comprise about 80 to 100 mole percent, based on the total second polyester diacid residues, of the residues of terephthalic acid. For example, the diacid residues of the second polyester may comprise about 85 to 100 mole percent of the residues of terephthalic acid. Some additional examples of terephthalic acid residue content in the second polyester (B) are about 90 to 100 mole percent, greater than about 90 mole percent, about 92 mole percent, about 95 mole percent, about 97 mole percent, about 99 mole percent, and 100 mole percent.

The diacid residues of the second polyester (B) may further comprise from 0 to about 20 mole percent of the residues of a modifying dicarboxylic acid containing 4 to 40 carbon atoms if desired. In one embodiment, the modifying dicarboxylic acid can comprise aromatic dicarboxylic acids, other than terephthalic or isophthalic acids, containing 8 to about 16 carbon atoms, cycloaliphatic dicarboxylic acids containing 8 to about 16 carbon atoms, acyclic dicarboxylic acids containing about 2 to about 16 carbon atoms, or mixtures thereof may be used. For example, the first polyester may comprise 0 to about 20 mole percent of the residues of a modifying dicarboxylic acid selected from malonic acid, succinic acid, glutaric acid, 1,3-cyclohexanedicarboxylic, 1,4-cyclohexanedicarboxylic acid, adipic acid, oxalic acid, suberic acid, sebacic acid, azelaic acid, dimer acid, pimelic acid, dodecanedioic acid, sulfoisophthalic acid, 2,6-decahydronaphthalenedicarboxylic acid, 4,4′-oxybenzoic acid, 3,3′- and 4,4′-stilbenedicarboxylic acid, 4,4′-dibenzyldicarboxylic acid, 1,4-, 1,5-, 2,3-, 2,6, and 2,7-naphthalenedicarboxylic acids, and combinations thereof. Where cis and trans isomers are possible, the pure cis or trans or a mixture of cis and trans isomers may be used.

The second polyester (B) comprises diol residues that comprise about 10 to about 50 mole percent, based on the total second polyester diol residues, of the residues of 2,2,4,4-tetramethyl-1,3-cyclobutanediol (abbreviated herein as “TMCD”) and about 50 to about 90 mole percent of the residues of 1,4-cyclohexanedimethanol. Other examples of TMCD and 1,4-CHDM mole percentage ranges in the second polyester include, but are not limited to about 15 to about 50 mole percent of the residues of TMCD and about 50 to about 85 mole percent of the residues of 1,4-CHDM; about 20 to about 50 mole percent of the residues of TMCD and about 50 to about 80 mole percent of the residues of 1,4-CHDM; about 20 to about 45 mole percent of the residues of TMCD and about 55 to about 80 mole percent of the residues of 1,4-CHDM; about 20 to about 40 mole percent of the residues of TMCD and about 60 to about 80 mole percent of the residues of 1,4-CHDM; about 20 to about 35 mole percent of the residues of TMCD and about 65 to about 80 mole percent of the residues of 1,4-CHDM; and about 20 to about 30 mole percent of the residues of TMCD and about 70 to about 80 mole percent of the residues of 1,4-CHDM. Some additional examples of TMCD content in the second polyester are about 10 mole percent, about 12 mole percent, about 14 mole percent, about 16 mole percent, about 18 mole percent, about 20 mole percent, about 22 mole percent, about 24 mole percent, about 26 mole percent, about 28 mole percent, about 30 mole percent, about 32 mole percent, about 34 mole percent, about 36 mole percent, about 38 mole percent, about 40 mole percent, about 42 mole percent, about 44 mole percent, about 46 mole percent, about 48 mole percent, and about 50 mole percent. The remaining diol content can comprise from about 50 to about 90 mole percent 1,4-CHDM and up to 10 mole percent of at least one modifying diol as set forth below. Some further examples of mole percentages of the residues of 1,4-CHDM in the second polyester are about 50 mole percent, about 52 mole percent, about 54 mole percent, about 56 mole percent, about 58 mole percent, about 60 mole percent, about 62 mole percent, about 64 mole percent, about 66 mole percent, about 68 mole percent, about 70 mole percent, about 72 mole percent, about 74 mole percent, about 76 mole percent, about 78 mole percent, about 80 mole percent, about 82 mole percent, about 84 mole percent, about 86 mole percent, about 88 mole percent, and about 90 mole percent.

In one embodiment, for example, the second polyester can comprise about 95 to 100 mole percent of the residues of terephthalic acid, about 20 to about 50 mole percent of the residues of 2,2,4,4-tetramethyl-1,3-cyclobutanediol, and about 50 to about 80 mole percent of the residues of 1,4-cyclohexanedimethanol. In another example, the second polyester can comprise about 95 to 100 mole percent of the residues of terephthalic acid, about 20 to about 30 mole percent of the residues of 2,2,4,4-tetramethyl-1,3-cyclobutanediol, and about 70 to about 80 mole percent of the residues of 1,4-cyclohexanedimethanol.

The second polyester also may comprise from 0 to about 10 mole percent of at least one modifying diol. Some representative examples of modifying diols are as listed above and include propylene glycol, 1,3-propanediol, 2,4-dimethyl2-ethylhexane-1,3-diol, 2,2-dimethyl-1,3-propanediol, diethylene glycol, 2-ethyl-2-butyl-1,3-propanediol, 2-ethyl-2-isobutyl-1,3-propanediol, 1,3-butanediol, 1,4-butanediol, neopentyl glycol, 1,5-pentanediol, 1,6-hexanediol, 1,8-octanediol, 2,2,4-trimethyl-1,6-hexanediol, thiodiethanol, 1,2-cyclohexanedimethanol, 1,3-cyclohexanedimethanol, and the like.

As described above, the cycloaliphatic diols, for example, 1,4-cyclohexanedimethanol and TMCD may be present as their pure cis or trans isomers or as a mixture of cis and trans isomers. For example, the second polyester can comprise 1,4-CHDM and TMCD residues that independently may have a cis:trans molar ratio of about 60:40 to about 40:60. Other examples of cis:trans ratios are about 70:30 to about 30:70 and about 80:20 to about 20:80. For example, the second polyester can comprise residues of 2,2,4,4-tetramethyl-1,3-cyclobutanediol that comprise about 60 to 100 mole percent cis 2,2,4,4-tetramethyl-1,3-cyclobutanediol and about 40 to 0 mole percent trans 2,2,4,4-tetramethyl-1,3-cyclobutanediol, based on the total moles of 2,2,4,4-tetramethyl-1,3-cyclobutanediol residues. In another embodiment, the second polyester can comprise about 80 to 100 mole percent of the residues of cis 2,2,4,4-tetramethyl-1,3-cyclobutanediol and about 20 to 0 mole percent of the residues of trans 2,2,4,4-tetramethyl-1,3-cyclobutanediol. In other embodiments, the molar percentages for cis and/or trans 2,2,4,4,-tetramethyl-1,3-cyclobutanediol are greater than 50 mole percent cis and less than 50 mole percent trans; greater than 55 mole percent cis and less than 45 mole percent trans; 30 to 70 mole percent cis and 70 to 30 mole percent trans; 40 to 60 mole percent cis and 60 to 40 mole percent trans; 50 to 70 mole percent trans and 50 to 30 mole percent cis; 50 to 70 mole percent cis and 50 to 30 mole percent trans; 60 to 70 mole percent cis and 30 to 40 mole percent trans; or greater than 70 mole percent cis and less than 30 mole percent trans, wherein the total mole percentages for cis and trans 2,2,4,4-tetramethyl-1,3-cyclobutanediol is equal to 100 mole percent.

The first and second polyesters of the miscible blend generally will have inherent viscosity values in the range of about 0.1 dL/g to about 1.4 dL/g. Additional examples of IV ranges include about 0.65 dL/g to about 1.0 dL/g and about 0.7 dL/g to about 0.85 dL/g. In another example, the second polyester can have an inherent viscosity of about 0.5 to about 0.80 dL/g. In still another example, the inherent viscosity of the second polyester is about 0.55 to about 0.75 dL/g. As described previously, inherent viscosity is measured at 25° C. using 0.5 grams of polymer per 100 ml of a solvent comprising 60 weight percent phenol and 40 weight percent tetrachloroethane.

The first and second polyesters of the blends of the present invention are amorphous or semi-crystalline and have glass transition temperatures of about 55 to about 140° C. The term “semicrystalline,” as used herein, means that the polymer contains two phases: an ordered crystalline phase and an unordered amorphous phase. Polymers with a semicrystalline morphology exhibit both a crystalline melting temperature (abbreviated herein as “Tm”) and a glass transition temperature (“Tg”) and may be distinguished from “amorphous” polymers, which exhibit only a glass transition temperature. The term glass transition temperature as used herein, refers to the Tg values determined using differential scanning calorimetry (“DSC”), typically using a scan rate of 20° C./min. An example of a DSC instrument is TA Instruments 2920 Differential Scanning Calorimeter. For example, the first polyester, typically, can have a glass transition temperature of about 60 to 100° C. Typical Tg's for the second polyester are in the range of about 90 to 140° C. In another example, the second polyester can have a Tg of about 100 to about 135° C.

Another embodiment of our invention is a polyester blend comprising:

A. about 10 to 90 weight percent of a first polyester comprising:
i. diacid residues comprising about 60 to 80 mole percent, based on the total first polyester diacid residues, of the residues of terephthalic acid and about 20 to about 40 mole percent of the residues of isophthalic acid; and
ii. diol residues comprising about 70 to 100 mole percent, based on the total first polyester diol residues, of the residues of 1,4-cyclohexanedimethanol and about 0 to about 30 mole percent of the residues of ethylene glycol; and
   B. about 10 to 90 weight percent of a second polyester comprising:
i. diacid residues comprising about 90 to 100 mole percent, based on the total second polyester diacid residues, of the residues of terephthalic acid; and
ii. diol residues comprising about 20 to about 50 mole percent, based on the total second polyester diol residues, of the residues of 2,2,4,4-tetramethyl-1,3-cyclobutanediol and about 50 to about 80 mole percent of the residues of 1,4-cyclohexanedimethanol;
wherein the second polyester has an inherent viscosity of about 0.50 to about 0.75 dL/g and a glass transition temperature of about 100 to about 130° C. and the blend exhibits a single glass transition temperature by differential scanning calorimetry.
   It should be understood that the above polyester blend is intended to include the various embodiments of the first and second polyesters, weight percentages of the first and second polyesters, mole percentages of terephthalic acid, isophthalic acid, TMCD, CHDM, modifying diacids and diols, catalysts, phosphorus additives, glass transition temperatures, incorporation of regrind, melt flow, and inherent viscosities described herein. For example, the polyester blend can comprise about 40 to about 60 weight percent of the first polyester and about 40 to about 60 mole percent of the second polyester. In another embodiment, for example, the second polyester can comprise residues of 2,2,4,4-tetramethyl-1,3-cyclobutanediol that comprise about 60 to 100 mole percent cis 2,2,4,4-tetramethyl-1,3-cyclobutanediol and about 40 to 0 mole percent trans 2,2,4,4-tetramethyl-1,3-cyclobutanediol, based on the total moles of 2,2,4,4-tetramethyl-1,3-cyclobutanediol.

The first polyester (A) and the second polyester (B), also may independently contain a branching agent. For example, the weight percent ranges for the branching agent can be about 0.01 to about 10 weight percent, or about 0.1 to about 1.0 weight percent, based on the total weight percent of polyester (A) or polyester (B). Conventional branching agents include polyfunctional acids, anhydrides, alcohols and mixtures thereof. The branching agent may be a polyol having 3 to 6 hydroxyl groups, a polycarboxylic acid having 3 or 4 carboxyl groups, or a hydroxy acid having a total of 3 to 6 hydroxyl and carboxyl groups. Examples of such compounds include trimellitic acid or anhydride, trimesic acid, pyromellitic anhydride, trimethylolethane, trimethylolpropane, and the like.

The first and second polyesters of the blend are readily prepared from the appropriate dicarboxylic acids, esters, anhydrides, or salts, and the appropriate diol or diol mixtures using typical polycondensation reaction conditions. They may be made by continuous, semi-continuous, and batch modes of operation and may utilize a variety of reactor types. Examples of suitable reactor types include, but are not limited to, stirred tank, continuous stirred tank, slurry, tubular, wiped-film, falling film, or extrusion reactors. The process is operated advantageously as a continuous process for economic reasons and to produce superior coloration of the polymer as the polyester may deteriorate in appearance if allowed to reside in a reactor at an elevated temperature for too long a duration.

The reaction of the diol and dicarboxylic acid may be carried out using conventional polyester polymerization conditions or by melt phase processes, but those with sufficient crystallinity may be made by melt phase followed by solid phase polycondensation techniques. For example, when preparing the polyester by means of an ester interchange reaction, i.e., from the ester form of the dicarboxylic acid components, the reaction process may comprise two steps. In the first step, the diol component and the dicarboxylic acid component, such as, for example, dimethyl terephthalate, are reacted at elevated temperatures, typically, about 150° C. to about 250° C. for about 0.5 to about 8 hours at pressures ranging from about 0.0 kPa gauge to about 414 kPa gauge (60 pounds per square inch, “psig”). Generally, the temperature for the ester interchange reaction ranges from about 180° C. to about 230° C. for about 1 to about 4 hours at pressure ranges from about 103 kPa gauge (15 psig) to about 276 kPa gauge (40 psig). Thereafter, the reaction product is heated under higher temperatures and under reduced pressure to form the polyester with the elimination of diol, which is readily volatilized under these conditions and removed from the system. This second step, or polycondensation step, is continued under higher vacuum and a temperature which generally ranges from about 230° C. to about 350° C. for about 0.1 to about 6 hours until a polymer having the desired degree of polymerization, as determined by inherent viscosity, is obtained. The polycondensation step may be conducted under reduced pressure which ranges from about 53 kPa (400 torr) to about 0.013 kPa (0.1 torr). Stirring or appropriate conditions are used in both stages to ensure adequate heat transfer and surface renewal of the reaction mixture. The reaction rates of both stages are increased by appropriate catalysts such as, for example, alkoxy titanium compounds, alkali metal hydroxides and alcoholates, salts of organic carboxylic acids, alkyl tin compounds, metal oxides, and the like. A three-stage manufacturing procedure, similar to that described in U.S. Pat. No. 5,290,631, may also be used, particularly when a mixed monomer feed of acids and esters is employed.

To ensure that the reaction of the diol component and dicarboxylic acid component by an ester interchange reaction is driven to completion, it is sometimes desirable to employ about 1.05 to about 2.5 moles of diol component to one mole dicarboxylic acid component. Persons of skill in the art will understand, however, that the ratio of diol component to dicarboxylic acid component is generally determined by the design of the reactor in which the reaction process occurs.

In the preparation of polyester by direct esterification, i.e., from the acid form of the dicarboxylic acid component, polyesters are produced by reacting the dicarboxylic acid or a mixture of dicarboxylic acids with the diol component or a mixture of diol components and the branching monomer component, if present. The reaction is conducted at a pressure of from about 7 kPa gauge (1 psig) to about 1379 kPa gauge (200 psig), preferably less than 689 kPa (100 psig) to produce a low molecular weight polyester product having an average degree of polymerization of about 1.4 to about 10. The temperatures employed during the direct esterification reaction typically range from about 180° C. to about 280° C., more preferably ranging from about 220° C. to about 270° C. This low molecular weight polymer may then be polymerized by a polycondensation reaction. Examples of the catalyst materials that may be used in the synthesis of the polyesters utilized in the present invention include titanium, manganese, zinc, cobalt, antimony, gallium, lithium, calcium, silicon and germanium. Such catalyst systems are described, for example, in U.S. Pat. Nos. 3,907,754, 3,962,189, 4,010,145, 4,356,299, 5,017,680, 5,668,243 and 5,681,918. For example, the catalyst can comprise titanium and manganese. In another example, the catalyst comprises titanium. The amount of catalytic metal typically may range from about 5 to 100 ppm. In another example, titanium concentrations of about 5 to about 35 ppm can be used in order to provide polyesters having good color, thermal stability and electrical properties. Phosphorus compounds frequently are used in combination with the catalyst metals. Up to about 100 ppm of phosphorus typically may be used.

The first and second polyesters of the blend can be prepared with titanium based catalysts. In the case of the second polyester, the incorporation of 2,2,4,4-tetramethyl-1,3-cyclobutanediol can be further improved by use of tin-based catalysts in addition to the titanium-based catalysts. Generally, the color of these first and second polyester can be improved with the addition during polymerization of certain levels of phosphorus containing compounds. Therefore, in another embodiment of the invention, the second polyester can comprise phosphorus atoms.

Phosphorus atoms can be added to the second polyester as one or more phosphorus compounds. For example, phosphorus atoms can be added to the second polyester as at least one alkyl phosphate ester, aryl phosphate ester, mixed alkyl aryl phosphate ester, diphosphite, salt of phosphoric acid, phosphine oxide, mixed alkyl aryl phosphite, reaction products thereof, or mixtures thereof. The phosphate esters include esters in which the phosphoric acid is fully esterified or only partially esterified. Some examples of alkyl, alkyl aryl, and aryl phosphate esters that can be added to the second polyester of our blends include, but are not limited to, dibutylphenyl phosphate, triphenyl phosphate, tricresyl phosphate, tributyl phosphate, mixtures of tributyl phosphate and tricresyl phosphate, mixtures of isocetyl diphenyl phosphate and 2-ethylhexyl diphenyl phosphate, tri-2-ethylhexyl phosphate, trioctyl phosphate, MERPOL® A, or mixtures thereof. MERPOL® A is an ethoxylated phosphate nonionic surfactant commercially available from Stepan Chemical Co. The CAS Registry number for MERPOL® A is 37208-27-8.

The amounts of the first and second polyesters in the blend may vary widely. The amounts of each of the first and second polyesters in the blend typically will range from about 5 to about 95 weight percent, based on the total weight of the blend. For example, the polyester blend may comprise about 20 to about 80 weight percent of the first polyester (A) and about 20 to about 80 weight percent of the second polyester (B). Other weight percentage ranges for each of the first and second polyesters are about 40 to about 60 weight percent and about 50 weight percent. For example, the polyester blend may comprise about 40 to about 60 weight percent of a first polyester (A), comprising about 60 to 80 mole percent of the residues of terephthalic acid, about 20 to about 40 mole percent isophthalic acid, about 80 to about 100 mole percent of the residues of 1,4-cyclohexanedimethanol, and about 0 to about 20 mole percent of the residues of ethylene glycol; and about 60 to about 40 weight percent of a second polyester (B), comprising about 95 to 100 mole percent of the residues of terephthalic acid, about 20 to about 50 mole percent of the residues of 2,2,4,4-tetramethyl-1,3-cyclobutanediol, and about 50 to about 80 mole percent of the residues of 1,4-cyclohexanedimethanol. In another example, the polyester blend can comprise about 50 weight percent of the first polyester (A) and about 50 weight percent of the second polyester (B). Persons having ordinary skill in the art will recognize that the polyester blend of the instant invention can comprise any of the compositions described hereinabove for the first and second polyesters, which may in turn be combined in any of the above weight percentages.

The polyester blend may further comprise one or more antioxidants, melt strength enhancers, chain extenders, flame retardants, fillers, acid scavengers, dyes, colorants, pigments, antiblocking agents, flow enhancers, impact modifiers, antistatic agents, processing aids, mold release additives, plasticizers, slip agents, stabilizers, waxes, UV absorbers, optical brighteners, lubricants, pinning additives, foaming agents, antistats, nucleators, glass beads, metal spheres, ceramic beads, carbon black, crosslinked polystyrene beads, and the like. Colorants, sometimes referred to as toners, may be added to impart a desired neutral hue and/or brightness to the polyester blend. For example, the polyester blend may comprise 0 to about 30 weight percent of one or more fillers. Representative examples of fillers include calcium carbonate, talc, clay, mica, zeolites, wollastonite, kaolin, diatomaceous earth, TiO2, NH4Cl, silica, calcium oxide, sodium sulfate, and calcium phosphate. Use of titanium dioxide and other pigments or dyes, might be included, for example, to control whiteness of films produced from the blend, or to make a colored film.

The first and second polyesters of the blends of the invention can comprise at least one chain extender. Suitable chain extenders include, but are not limited to, multifunctional (including, but not limited to, bifunctional) isocyanates, multifunctional epoxides including, for example, epoxylated novolacs, and phenoxy resins. In certain embodiments, chain extenders may be added at the end of the polymerization process or after the polymerization process. If added after the polymerization process, chain extenders can be incorporated by compounding or by addition during article-forming processes such as, for example, injection molding or extrusion. The amount of chain extender used can vary depending on the specific monomer composition used and the physical properties desired, but is generally about 0.1 percent by weight to about 10 percent by weight, based on the total weight of the first or second polyester.

The polyester blends of the invention also can contain other non-polyester polymer components. Thus, another embodiment of the present invention are the polyester blends, as described above, that further comprise up to 50 weight percent of a non-polyester polymer. Non-limiting examples of polymers which may be included in the polyester blends of the invention are polyamides, polyethers, polyolefins, polyacrylates and substituted polyacrylates, rubbers or elastomers, polycarbonates, polysulphones, polyphenyl sulphides, oxides, and ethers, polyketones, polyimides, halogenated polymers, organometallic polymers, water soluble polymers, carbohydrates, ionomers, styrenic copolymers, polyetherimides, polyphenyl oxides, urethanes, cyclic olefins, polyether etherketones, polyacetals, polyvinyl chlorides, alcohols, acetates, and the like.

The polyester blend may be prepared by melt blending or compounding the first and second polyester components according to methods well known to persons skilled in the art. The term “melt,” as used herein, includes, but is not limited to, merely softening the polymers. The melt blending method includes blending the polymers at temperatures sufficient to melt the first and second polyesters, typically about 200 to about 300° C. The melt blending procedure may be performed in an agitated, heated vessel such as, for example, an extruder, or in an injection molding machine. The blend may be cooled and pelletized for further use or the melt blend can be processed directly from this molten blend into film or other shaped articles by extrusion, calendering, thermoforming, blow-molding, extrusion blow-molding, injection molding, compression molding, casting, drafting, tentering, or blowing. For example, the first and second polyesters, typically in pellet form, may be mixed together by weight in a tumbler and then placed in a hopper of an extruder for melt compounding. Alternatively, the pellets may be added to the hopper of an extruder by various feeders which meter the pellets in their desired weight ratios.

Another embodiment of our invention, therefore, is a process for the preparation of a miscible polyester blend, comprising melt blending:

A. about 5 to about 95 weight percent of at least one first polyester comprising:
i. diacid residues comprising about 50 to 100 mole percent, based on the total first polyester diacid residues, of the residues of terephthalic acid and 0 to about 50 mole percent of the residues of isophthalic acid; and
ii. diol residues comprising about 70 to 100 mole percent, based on the total first polyester diol residues, of the residues of 1,4-cyclohexanedimethanol and about 0 to about 30 mole percent of the residues of ethylene glycol; and
   B. about 5 to about 95 weight percent of at least one second polyester comprising:
i. diacid residues comprising about 80 to 100 mole percent, based on the total second polyester diacid residues, of the residues of terephthalic acid; and
ii. diol residues comprising about 10 to about 50 mole percent, based on the total second polyester diol residues, of the residues of 2,2,4,4-tetramethyl-1,3-cyclobutanediol and about 50 to about 90 mole percent of the residues of 1,4-cyclohexanedimethanol;
wherein the blend exhibits a single glass transition temperature by differential scanning calorimetry.

It should be understood that the polyester blend of our process includes the various embodiments of the polyester blends, first polyester, second polyester, branching agents, catalysts, and additives, as described hereinabove. In addition to melt-blending, the polyester blends also can be prepared by blending in solution. The solution-blending method includes dissolving the appropriate weight:weight ratio of the first polyester and second polyester in a suitable organic solvent such as methylene chloride or a 70:30 mixture of methylene chloride and hexafluoroisopropanol, mixing the solution, and separating the blend composition from solution by precipitation of the blend or by evaporation of the solvent. Solution-prepared blending methods are generally known in the polymers art.

The melt blending method, typically, is more economical and safer than the solution method, which requires the use of volatile solvents. The melt blending method also is more effective in providing clear blends. Any of the clear blends of the present invention that can be prepared by solution blending also can be prepared by the melt method. One of ordinary skill in the art will be able to determine the appropriate blending methods for producing the polyester blends of the present invention.

For example, the first and second polyesters of the blend may be blended in the melt by using a single screw or twin screw extruder. Additional components such as stabilizers, flame retardants, colorants, lubricants, release agents, impact modifiers, and the like may also be incorporated into the formulation. For example, the polyester blends can be produced via a melt extrusion compounding of the first polyester and the second polyester with any other blend components such as, for example, catalysts, dyes, toners, fillers, and the like. The polyester blends may be formed by dry blending solid particles or pellets of each of the first and second polyesters and then melt blending the mixture in a suitable mixing means such as an extruder, a roll mixer, or the like. Blending is conducted for a period of time that will yield a well dispersed, miscible blend that may easily be determined by those skilled in the art by DSC, for example. If desired, the polyester blend may be cooled and cut into pellets for further processing, extruded into films, sheets, profiles, and other shaped elements, injection or compression molded to form various shaped articles, or it may be formed into films and, optionally, uniaxially or biaxially stretched by means well known in the art.

In some embodiments, the polymer blends of the present invention can have a haze value measured on ⅛ inch (3.2 mm) molded samples of about 10 percent or less. In another embodiment, the blends of the invention can have haze value of about 0.2 to about 3 percent. In yet another embodiment, the polyester blends of the invention can have a percent transmission of about 70 to 100 percent. Percent haze and percent transmission can be determined using ASTM Method D1003. In another embodiment, the polymer blends also can exhibit a heat deflection temperature, at 455 kilopascals bar of about 60 to 130° C. (as measured by ASTM Method D648), a notched Izod impact strength at 23° C. of about 50 to 1250 joules/m (as determined by ASTM Method D256, a modulus of about 700 to 3500 MPa (as determined by ASTM Method D790), and a flexural strength of about 35 to about 103 MPa (5000 to 15,000 psi) as determined by ASTM Method D790. In another embodiment, the polyester blends can exhibit a notched Izod impact strength of no break. The tensile properties of the blend, determined according to ASTM Method D638 at 23° C., can have a tensile strength of about 31 to 69 MPa (about 4500 to about 10,000 psi), a break stress of about 31 to 69 MPa, and a tensile elongation at break of at least 50%.

Our invention also provides a shaped article comprising the miscible polyester blends set forth herein. It should be understood that the shaped article includes the various embodiments of the polyester blend, first polyester, and second polyester as described hereinabove. The shaped article can be produced by any method known in the art including, but not limited to, extrusion, calendering, thermoforming, blow-molding, extrusion blow-molding, injection stretch blow-molding, injection molding, injection blow-molding, compression molding, profile extrusion, cast extrusion, melt-spinning, drafting, tentering, or blowing. The shaped articles can have a single layer or contain multiple layers. Multilayer articles can be prepared in which the polyester blend is present in one or more layers or in which the blend of the invention and one or more different polymeric materials are present in separate layers. Some non-limiting examples of shaped articles comprising the polyester blends of our invention are sheets, films, fibers, tubes, preforms, containers, or bottles. For example, the shaped article can be an extruded article such as a film, sheet, or profile. In another example, the shaped article can be an injection molded part or component of a home appliance, electronic device, tool, automobile, medical device, and the like. In yet another example, the shaped article can be an injection molded jar, cosmetic article, decorative panel, or a component of a sign.

For example, the polyester blends of the present invention may be fabricated into shaped articles such as, for example, films, by any technique known in the art. Formation of films can be achieved by melt extrusion, as described, for example, in U.S. Pat. No. 4,880,592; by compression molding as described, for example, in U.S. Pat. No. 4,427,614; or by any other suitable method. The polyester blend may be fabricated into monolayer or multilayer films by any technique known in the art. For example, monolayer or multi-layer films may be produced by the well known cast film, blown film, and extrusion coating techniques, the latter including extrusion onto a substrate. Representative substrates include films, sheets, and woven and nonwoven fabrics. Monolayer or multilayer films produced by melt casting or blowing can be thermally bonded or sealed to a substrate using an adhesive.

For example, the polyester blends may be formed into a film using a conventional blown film apparatus. The film forming apparatus may be one which is referred to in the art as a “blown film” apparatus and includes a circular die head for bubble blown film through which the blend is forced and formed into a film “bubble”. The “bubble” is ultimately collapsed and formed into a film.

The polyester blend may also be formed into film or sheet using any method known to those skilled in the art including, but not limited to, extrusion and calendaring. In the extrusion process, the polyesters, typically in pellet form, are mixed together in a tumbler and then placed in a hopper of an extruder for melt compounding. Alternatively, the pellets may be added to the hopper of an extruder by various feeders, which meter the pellets in their desired weight ratios. Upon exiting the extruder the now homogenous polyester blend is shaped into a film. The shape of the film is not restricted in any way. For example, it may be a flat sheet or a tube. The film obtained may be stretched, for example, in a certain direction by 2 to 6 times the original dimensions.

The stretching method for the film may be by any of the methods known in the art such as, for example, the roll stretching method, long-gap stretching, the tenter-stretching method, and the tubular stretching method. With the use of any of these methods, it is possible to conduct biaxial stretching in succession, simultaneous biaxial stretching, uniaxial stretching, or a combination of these. Biaxial stretching in the machine direction and transverse direction may be done simultaneously or at different times by stretching first in one direction and then in the other direction.

In a general embodiment, the polymer blends of the invention are useful in making calendered film or sheet on calendering rolls. The polymer blend also may comprise one or more plasticizers to increase the flexibility and softness of calendared polyester film, improve the processing of the polyester, and help to prevent sticking of the polyester to the calender rolls. The calendered film or sheet, typically, can have a thickness in the range of about 2 mils (0.05 mm) to about 80 mils (2 mm).

The polyester blends also may be used to form shaped articles through injection molding, injection blow-molding, extrusion blow molding, and injection stretch-blow molding. A typical injection molding process softens the polyester blend in a heated cylinder, injecting it while molten under high pressure into a closed mold, cooling the mold to induce solidification, and ejecting the molded preform from the mold. For example, the polyester blends of the invention are well suited for the production of preforms with subsequent reheat stretch-blow molding of these preforms into the final bottle shapes having the desired properties. The injection molded preform is heated to suitable orientation temperature in the 100° C. to 150° C. range and then stretch-blow molded. The latter process consists of first stretching the hot preform in the axial direction by mechanical means such as by pushing with a core rod insert followed by blowing high pressure air (up to 500 psi) to stretch in the hoop direction. In this manner, a biaxially oriented blown bottle is made. Typical blow-up ratios range from about 5:1 to about 15:1.

The excellent transparency and low haze of the polyester blends of the invention enable the preparation of transparent, shaped articles with the incorporation of substantial amounts of scrap polymer or “regrind” from the shaped article forming process. Thus, another aspect of our invention is a shaped article that comprises any one of the polyester blends of the invention wherein the polyester blend comprises about 1 to about 50 weight percent recovered scrap from a shaped article forming process. In one embodiment, for example, the scrap can comprise the polymer blend of the invention or one or both of the individual first and second polyesters that are used to form the polyester blend. The term “regrind,” as used herein, is understood to have its commonly accepted meaning in art, that is, scrap polymer that recovered from an article forming process and ground into smaller particles. Often, regrind is sold as scrap for incorporation into shaped articles in which the transparency of the article is immaterial to its application. For certain shaped articles such as, for example, bottles and films used in packaging applications, low haze and high transparency are important features. The manufacture of these articles, in particular, multilayered articles, inherently produces large quantities of scrap polymer which frequently cannot be returned to the article-forming process because of the formation of unacceptable levels of haze. Because of the miscibility of the first and second polyesters and low haze of the blend, transparent, shaped articles may be produced from the compositions of the invention with the inclusion of regrind.

The invention also includes the following embodiments that are set forth below and in paragraphs [0051]-[0069]: a polyester blend comprising:

A. about 5 to about 95 weight percent of at least one first polyester comprising:
i. diacid residues comprising about 50 to 100 mole percent, based on the total first polyester diacid residues, of the residues of terephthalic acid and 0 to about 50 mole percent of the residues of isophthalic acid; and
ii. diol residues comprising about 70 to 100 mole percent, based on the total first polyester diol residues, of the residues of 1,4-cyclohexanedimethanol and about 0 to about 30 mole percent of the residues of ethylene glycol; and
   B. about 5 to about 95 weight percent of at least one second polyester comprising:
i. diacid residues comprising about 80 to 100 mole percent, based on the total second polyester diacid residues, of the residues of terephthalic acid; and
ii. diol residues comprising about 10 to about 50 mole percent, based on the total second polyester diol residues, of the residues of 2,2,4,4-tetramethyl-1,3-cyclobutanediol and about 50 to about 90 mole percent of the residues of 1,4-cyclohexanedimethanol;
wherein the blend exhibits a single glass transition temperature by differential scanning calorimetry.

A polyester blend that includes the embodiments of paragraph [0050] which comprises about 20 to about 80 weight percent of the first polyester and about 20 to 80 weight percent of the second polyester.

A polyester blend that includes the embodiments of paragraph [0050] which comprises about 40 to about 60 weight percent of the first polyester and about 40 to 60 weight percent of the second polyester.

A polyester blend that includes the embodiments of any one of paragraphs [0050]-[0052], wherein the dicarboxylic acid residues of each of the first and second polyesters independently further comprise 0 to about 20 mole percent of the residues of a modifying dicarboxylic acid selected from malonic acid, succinic acid, glutaric acid, 1,3-cyclohexanedicarboxylic, 1,4-cyclohexanedicarboxylic acid, adipic acid, oxalic acid, suberic acid, sebacic acid, azelaic acid, dimer acid, pimelic acid, dodecanedioic acid, sulfoisophthalic acid, 2,6-decahydronaphthalenedicarboxylic acid, 4,4′-oxybenzoic acid, 3,3′- and 4,4′-stilbenedicarboxylic acid, 4,4′-dibenzyldicarboxylic acid, 1,4-, 1,5-, 2,3-, 2,6, and 2,7-naphthalenedicarboxylic acids, and combinations thereof; and the diol residues of each of the first and second polyesters independently further comprise 0 to about 10 mole percent of the residues of a modifying diol selected from propylene glycol, 1,3-propanediol, 2,4-dimethyl-2-ethylhexane-1,3-diol, 2,2-dimethyl-1,3-propanediol, diethylene glycol, 2-ethyl-2-butyl-1,3-propanediol, 2-ethyl-2-isobutyl-1,3-propanediol, 1,3-butanediol, 1,4-butanediol, neopentyl glycol, 1,5-pentanediol, 1,6-hexanediol, 1,8-octanediol, 2,2,4-trimethyl-1,6-hexanediol, thiodiethanol, 1,2-cyclohexanedimethanol, 1,3-cyclohexanedimethanol, polyethylene glycol, diethylene glycol, polytetramethylene glycol, and combinations thereof.

A polyester blend that includes the embodiments of any one of paragraphs [0050]-[0053], wherein the diacid residues of the first polyester comprise about 95 to 100 mole percent of the residues of terephthalic acid and 0 to about 5 mole percent of the residues of isophthalic acid, and the diol residues of the first polyester comprise about 80 to about 100 mole percent of the residues of 1,4-cyclohexanedimethanol and about 0 to about 20 mole percent of the residues of ethylene glycol.

A polyester blend that includes the embodiments of any one of paragraphs [0050]-[0053], wherein the diacid residues of the first polyester comprise about 60 to about 70 mole percent of the residues of terephthalic acid and about 30 to about 40 percent of the residues of isophthalic acid and the diol residues of the first polyester comprise about 95 to about 100 mole percent of the residues of 1,4-cyclohexanedimethanol.

A polyester blend that includes the embodiments of any one of paragraphs [0050]-[0055], wherein the diacid residues of the second polyester comprise about 95 to 100 mole percent of the residues of terephthalic acid and the diol residues of the second polyester comprise about 20 to about 50 mole percent of the residues of 2,2,4,4-tetramethyl-1,3-cyclobutanediol and about 50 to about 80 mole percent of the residues of 1,4-cyclohexanedimethanol.

A polyester that includes the embodiments of paragraph [0056], wherein the diol residues of the second polyester comprise about 20 to about 30 mole percent of the residues of 2,2,4,4-tetramethyl-1,3-cyclobutanediol and about 70 to about 80 mole percent of the residues of 1,4-cyclohexanedimethanol.

A polyester blend that includes the embodiments of any one of paragraphs [0050]-[0057], wherein the second polyester has an inherent viscosity of about 0.5 to about 0.80 dL/g.

A polyester blend that includes the embodiments of any one of paragraphs [0050]-[0058], wherein the second polyester has a glass transition temperature of about 100 to about 135° C.

A polyester blend that includes the embodiments of any one of paragraphs [0050]-[0059], wherein the residues of 2,2,4,4-tetramethyl-1,3-cyclobutanediol comprise about 60 to 100 mole percent cis 2,2,4,4-tetramethyl-1,3-cyclobutanediol and about 40 to 0 mole percent trans 2,2,4,4-tetramethyl-1,3-cyclobutanediol, based on the total moles of 2,2,4,4-tetramethyl-1,3-cyclobutanediol residues.

A polyester blend that includes the embodiments of paragraph [0060], wherein the residues of 2,2,4,4-tetramethyl-1,3-cyclobutanediol comprise about 80 to 100 mole percent cis 2,2,4,4-tetramethyl-1,3-cyclobutanediol and about 20 to 0 mole percent trans 2,2,4,4-tetramethyl-1,3-cyclobutanediol, based on the total moles of 2,2,4,4-tetramethyl-1,3-cyclobutanediol.

A polyester blend that includes the embodiments of any one of paragraphs [0050]-[0061], wherein the second polyester comprises phosphorus atoms.

A polyester blend that includes the embodiments of paragraph [0062], wherein the phosphorus atoms are added to the second polyester as at least one alkyl phosphate ester, aryl phosphate ester, mixed alkyl aryl phosphate ester, diphosphite, salt of phosphoric acid, phosphine oxide, mixed alkyl aryl phosphite, reaction products thereof, or mixtures thereof.

A shaped article comprising the polyester blend of any one of the preceding paragraphs [0050]-[0063].

A shaped article that includes the embodiments of paragraph [0064], which is formed by extrusion, calendering, thermoforming, blow-molding, extrusion blow-molding, injection stretch blow-molding, injection molding, injection blow-molding, compression molding, profile extrusion, cast extrusion, melt-spinning, drafting, tentering, or blowing.

A shaped article that includes the embodiments of paragraph [0065], which is a sheet, film, fiber, tube, preform, container, or bottle.

A shaped article that includes the embodiments of paragraph [0065], which is a component of a home appliance.

A shaped article that includes the embodiments of any one of paragraphs [0064]-[0067], wherein the polyester blend comprises about 1 to about 50 weight percent recovered scrap from a shaped article forming process.

A process for the preparation of a polyester blend, comprising melt blending the first and second polyesters as set forth in paragraphs [0050]-[0063].

The invention is further illustrated by the following examples.

### EXAMPLES

The inherent viscosity of the polyesters was determined in 60/40 (wt/wt) phenol/tetrachloroethane at a concentration of 0.5 g/100 ml at 25° C. according to standard methods that are described in ASTM Method D4603. The glass transition temperatures (Tg) were measured using Differential Scanning Calorimetry (DSC) following ASTM Method D3418 with minor modifications, and are shown in Tables 1 and 3. The sample weight was measured before each measurement and was between about 2 and 5 mg. Both first and second heating scans were performed at a scan rate of 20° C./minute. The composition of the neat resins was determined by proton nuclear magnetic resonance spectroscopy (NMR). Clarity was determined by visual inspection. The miscibility of the blends was determined by the presence of a single glass transition temperature and clarity of the blended resin exiting the extruder after cooling. The following abbreviations are used throughout the examples:

| Abbreviation | Description |
|---|---|
| CHDM | 1,4-cyclohexanedimethanol |
| DBTO | Dibutyltin oxide |
| DMT | Dimethyl terephthalate |
| DEG | Diethylene glycol |
| DMTO | Dimethyl tin oxide |
| EG | Ethylene glycol |
| TMCD | 2,2,4,4-tetramethyl-1,3-cyclobutanediol |
| TPA | Terephthalic acid |
| NPG | Neopentyl glycol |
| IPA | Isophthalic acid |

The polyesters used to prepare the blends were prepared and characterized by conventional methods. Their compositions are shown in Table 1. In general, typical IV ranges for the polyesters shown in Table 1 are from about 0.55 to about 0.80.

TABLE 1
Neat polyesters used for blend preparation

| Polyester | TPA | IPA | NPG | TMCD | CHDM | EG | Tg (° C.) | Tg (° C.) |
|---|---|---|---|---|---|---|---|---|
| Number | (mol %) | (mol %) | (mol %) | (mol %) | (mol %) | (mol %) | 1^{st} Heat | 2^{nd} Heat |
| 1 | 100 | 0 | 0 | 23 | 77 | 0 | 112 | 111 |
| 2 | 100 | 0 | 0 | 33 | 67 | 0 | 117 | 115 |
| 3 | 100 | 0 | 0 | 44 | 56 | 0 | 128 | 126 |
| 4 | 100 | 0 | 0 | 0 | 1.5 | 98.5 | 78 | 81 |
| 5 | 100 | 0 | 0 | 0 | 12.5 | 87.5 | 78 | 79 |
| 6 | 100 | 0 | 0 | 0 | 31 | 69 | 80 | 83 |
| 7 | 100 | 0 | 0 | 0 | 39 | 61 | 78 | 83 |
| 8 | 100 | 0 | 0 | 0 | 62 | 38 | 83 | 86 |
| 9 | 100 | 0 | 0 | 0 | 81 | 19 | 88 | 91 |
| 10 | 100 | 0 | 0 | 0 | 100 | 0 | 86 | 88 |
| 11 | 74 | 26 | 0 | 0 | 100 | 0 | 91 | 89 |
| 12 | 100 | 0 | 33 | 0 | 0 | 67 | 77 | 78 |

### Comparative Examples C1-C14 and Examples 1-8

Preparation of Blends—The polyesters (A) and (B) were dried overnight in the presence of a desiccant in a forced air oven from 70 to 90° C., depending on the resin Tg. The polyester components were premixed by bag blending and then fed to a 19 mm APV™ screw extruder equipped with a moderate mixing-distributing screw design. The extruder was set at 250° C. at the feed zone and at 275° C. at the remaining 4 zones. All blends compounded at a screw RPM of 300 under similar thermal profiles. Some of the polymer melt exiting the die was quickly quenched as a strand in chilled water, while some polymer melt was collected on a room temperature surface and allowed to cool slowly. Visual haze was determined on the sample that was cooled slowly and is shown in Table 2. Comparative Examples C1 to C14 all exhibit some haze indicating low or partial miscibility. No haze was observed in Examples 1-8. Comparative Examples C12-C14 had a high level of haze and were opaque.

TABLE 2
Polyester Blends

| | Polyester (A) | Polyester (B) | Haze level |
|---|---|---|---|
| Example | (Polyester No.) | (Polyester No.) | (visual) |
| C1 | 4 | 1 | high |
| C2 | 4 | 3 | high |
| C3 | 5 | 1 | high |
| C4 | 5 | 3 | high |
| C5 | 6 | 1 | high |
| C6 | 6 | 3 | high |
| C7 | 7 | 1 | high |
| C8 | 7 | 2 | high |
| C9 | 7 | 3 | high |
| C10 | 8 | 1 | some |
| C11 | 8 | 3 | some |
| 1 | 9 | 1 | none |
| 2 | 9 | 2 | none |
| 3 | 9 | 3 | none |
| 4 | 10 | 1 | none |
| 5 | 10 | 3 | none |
| 6 | 11 | 1 | none |
| 7 | 11 | 2 | none |
| 8 | 11 | 3 | none |
| C12 | 12 | 1 | high |
| C13 | 12 | 2 | high |
| C14 | 12 | 3 | high |

The thermal properties of the polyester blends are shown in Table 3 and are based upon DSC analyses of samples of the quenched polymer blend strand. Both the first and second heats are shown in Table 3 along with the Tg of the component polyesters (A) and (B).

TABLE 3
Thermal Properties of Polyester Blends

| | Tg (° C.) | Tg (° C.) | 1^{st} heat | | 2^{nd} heat | | |
|---|---|---|---|---|---|---|---|
| | Polyester (A) | Polyester (B) | (° C.) | | (° C.) | | |
| Example | (2^{nd} Heat) | (2^{nd} Heat) | Tg1 | Tg2 | Tg1 | Tg2 | Miscibility |
| C1 | 81 | 111 | 76 | 110 | 79 | 107 | no |
| C2 | 81 | 126 | 77 | | 80 | 123 | no |
| C3 | 79 | 111 | 79 | 111 | 80 | 107 | no |
| C4 | 79 | 126 | 83 | 111 | 83 | 107 | no |
| C5 | 83 | 111 | 79 | 127 | 80 | 123 | no |
| C6 | 83 | 126 | 81 | 128 | 82 | 122 | no |
| C7 | 83 | 111 | 78 | 106 | 83 | 104 | no |
| C8 | 83 | 115 | 80 | 115 | 83 | 109 | no |
| C9 | 83 | 126 | 81 | 123 | 84 | 118 | no |
| C10 | 86 | 111 | 91 | 100 | 91 | 103 | partial |
| C11 | 86 | 126 | 90 | 126 | 91 | 113 | partial |
| 1 | 91 | 111 | 99 | | 98 | | yes |
| 2 | 91 | 115 | 100 | | 99 | | yes |
| 3 | 91 | 126 | 102 | | 103 | | yes |
| 4 | 88 | 111 | 103 | | 100 | | yes |
| 5 | 88 | 126 | 108 | | 108 | | yes |
| 6 | 89 | 111 | 95 | | 95 | | yes |
| 7 | 89 | 115 | 99 | | 98 | | yes |
| 8 | 89 | 126 | 100 | | 101 | | yes |
| C12 | 78 | 111 | 75 | 108 | 78 | 104 | no |
| C13 | 78 | 115 | 71 | 114 | 78 | 110 | no |
| C14 | 78 | 126 | 75 | 124 | 78 | 119 | no |

### Examples 9-13

Effect of Blend Composition on Physical Properties—The effect of composition on blend properties was determined by blending 2 polyesters, labeled in Table 4 as polyester (A) and polyester (B), in varying proportions and measuring the physical properties of the blends. Polyester (A) contained 65 mole percent terephthalic acid, 35 mole percent isophthalic acid, and 100 mole percent 1,4-cyclohexanedimethanol. Polyester (B) contained 100 mole percent terephthalic acid, 23 mole percent 2,2,4,4, tetramethyl-1,3-cyclobutanediol, and 77 mole percent cyclohexanedimethanol.

Polyester (A) was dried at 70° C. and polyester (B) was dried at 90° C. Blends were prepared in an 18 mm Leistritz twin screw extruder. The polymers were premixed by tumble blending and fed into the extruder and the extruded strand was pelletized. The pellets were injection molded into parts on a Toyo 90 injection molding machine. The extruder was run at 350 rpms at a feed rate to give a machine torque between 80-100%. Processing temperatures used were in the range of 240° C. to 270° C. The compositions and properties of the blends are shown in Table 4.

Heat deflection temperature, at 264 psi, was determined according to ASTM Method D648. Flexural modulus and flexural strength were determined according to ASTM Method D790. Tensile properties were determined according to ASTM Method D638. Notched Izod Impact Strengths were determined according to ASTM Method D256 using an average of 10 samples. Clarity was determined visually. Melt viscosity was determined using small-amplitude oscillatory shear (“SAOS”) rheology. The glass transition temperatures were determined as described previously.

TABLE 4
Effect of Blend Composition on Physical Properties

| Property | Units | | Ex 9 | Ex 10 | Ex 11 | Ex 12 | Ex 13 | |
|---|---|---|---|---|---|---|---|---|
| Polyester (A) | wt % | 100 | 85 | 70 | 50 | 30 | 15 | 0 |
| Polyester (B) | wt % | 0 | 15 | 30 | 50 | 70 | 85 | 100 |
| Heat Deflection Temp @264 psi | ° C. | 65 | 67 | 68 | 71 | 73 | 76 | 82 |
| Tensile Strength | MPa | 50 | 49 | 49 | 47 | 46 | 45 | 44 |
| Tensile Break Elongation | % | 288 | 221 | 185 | 172 | 164 | 131 | 132 |
| Flexural Modulus | MPa | 1672 | 1633 | 1623 | 1585 | 1540 | 1503 | 1464 |
| Flexural Strength | MPa | 65 | 63 | 64 | 64 | 64 | 64 | 63 |
| Melt Viscosity | | | | | | | | |
| 260° C. and 1 rad/sec | Poise | 1950 | 2110 | 2540 | 3030 | 3780 | 4260 | 4980 |
| 280° C. and 1 rad/sec | Poise | 1120 | 1220 | 1350 | 1560 | 1890 | 2050 | 2490 |
| Notched Izod Impact Strength: | | | | | | | | |
| Number of Complete breaks | | 10 | 10 | 9 | 0 | 1 | 0 | 0 |
| Avg. Strength (Comp. break) | J/m | 60 | 84 | 74 | 0 | 107 | 0 | 0 |
| Number of Partial Breaks | | 0 | 0 | 0 | 0 | 9 | 10 | 10 |
| Avg. Strength (Partial break) | J/m | — | — | — | — | 1009 | 899 | 855 |
| Number of No Breaks | | 0 | 0 | 1 | 10 | 0 | 0 | 0 |
| DSC Tg (second cycle) | ° C. | 85 | 87 | 89 | 94 | 100 | 105 | 108 |
| Visual Clarity | | clear | clear | clear | clear | clear | clear | clear |

We claim:

1. A polyester blend comprising:
A. about 5 to about 95 weight percent of at least one first polyester comprising:
i. diacid residues comprising about 50 to 100 mole percent, based on the total first polyester diacid residues, of the residues of terephthalic acid and 0 to about 50 mole percent of the residues of isophthalic acid; and
ii. diol residues comprising about 70 to 100 mole percent, based on the total first polyester diol residues, of the residues of 1,4-cyclohexanedimethanol and about 0 to about 30 mole percent of the residues of ethylene glycol;
and
B. about 5 to about 95 weight percent of at least one second polyester comprising:
i. diacid residues comprising about 80 to 100 mole percent, based on the total second polyester diacid residues, of the residues of terephthalic acid; and
ii. diol residues comprising about 10 to about 50 mole percent, based on the total second polyester diol residues, of the residues of 2,2,4,4-tetramethyl-1,3-cyclobutanediol and about 50 to about 90 mole percent of the residues of 1,4-cyclohexanedimethanol;
wherein said blend exhibits a single glass transition temperature by differential scanning calorimetry.

2. The polyester blend according to claim 1 which comprises about 20 to about 80 weight percent of said first polyester and about 20 to 80 weight percent of said second polyester.

3. The polyester blend according to claim 1 which comprises about 40 to about 60 weight percent of said first polyester and about 40 to 60 weight percent of said second polyester.

4. The polyester blend according to claim 1 wherein said dicarboxylic acid residues of each of said first and second polyesters independently further comprise 0 to about 20 mole percent of the residues of a modifying dicarboxylic acid selected from malonic acid, succinic acid, glutaric acid, 1,3-cyclohexanedicarboxylic, 1,4-cyclohexanedicarboxylic acid, adipic acid, oxalic acid, suberic acid, sebacic acid, azelaic acid, dimer acid, pimelic acid, dodecanedioic acid, sulfoisophthalic acid, 2,6-decahydronaphthalenedicarboxylic acid, 4,4′-oxybenzoic acid, 3,3′- and 4,4′-stilbenedicarboxylic acid, 4,4′-dibenzyldicarboxylic acid, 1,4-, 1,5-, 2,3-, 2,6, and 2,7-naphthalenedicarboxylic acids, and combinations thereof; and said diol residues of each of said first and second polyesters independently further comprise 0 to about 10 mole percent of the residues of a modifying diol selected from propylene glycol, 1,3-propanediol, 2,4-dimethyl-2-ethylhexane-1,3-diol, 2,2-dimethyl-1,3-propanediol, diethylene glycol, 2-ethyl-2-butyl-1,3-propanediol, 2-ethyl-2-isobutyl-1,3-propanediol, 1,3-butanediol, 1,4-butanediol, neopentyl glycol, 1,5-pentanediol, 1,6-hexanediol, 1,8-octanediol, 2,2,4-trimethyl-1,6-hexanediol, thiodiethanol, 1,2-cyclohexanedimethanol, 1,3-cyclohexanedimethanol, polyethylene glycol, diethylene glycol, polytetramethylene glycol, and combinations thereof.

5. The polyester blend according to claim 1, wherein said diacid residues of said first polyester comprise about 95 to 100 mole percent of the residues of terephthalic acid and 0 to about 5 mole percent of the residues of isophthalic acid, and said diol residues of said first polyester comprise about 80 to about 100 mole percent of the residues of 1,4-cyclohexanedimethanol and about 0 to about 20 mole percent of the residues of ethylene glycol.

6. The polyester blend according to claim 1, wherein said diacid residues of said first polyester comprise about 60 to about 70 mole percent of the residues of terephthalic acid and about 30 to about 40 percent of the residues of isophthalic acid, and said diol residues of said first polyester comprise about 95 to about 100 mole percent of the residues of 1,4-cyclohexanedimethanol.

7. The polyester blend according to claim 1, wherein said diacid residues of said second polyester comprise about 95 to 100 mole percent of the residues of terephthalic acid and said diol residues of said second polyester comprise about 20 to about 50 mole percent of the residues of 2,2,4,4-tetramethyl-1,3-cyclobutanediol and about 50 to about 80 mole percent of the residues of 1,4-cyclohexanedimethanol.

8. The polyester blend according to claim 7, wherein said diol residues of said second polyester comprise about 20 to about 30 mole percent of the residues of 2,2,4,4-tetramethyl-1,3-cyclobutanediol and about 70 to about 80 mole percent of the residues of 1,4-cyclohexanedimethanol.

9. The polyester blend according to claim 1 wherein said second polyester has an inherent viscosity of about 0.5 to about 0.80 dL/g.

10. The polyester blend according to claim 9 wherein said second polyester has an inherent viscosity of about 0.55 to about 0.75 dL/g.

11. The polyester blend according to claim 1 wherein said second polyester has a glass transition temperature of about 100 to about 135° C.

12. The polyester blend according to claim 1, wherein said residues of 2,2,4,4-tetramethyl-1,3-cyclobutanediol comprise about 60 to 100 mole percent cis 2,2,4,4-tetramethyl-1,3-cyclobutanediol and about 40 to 0 mole percent trans 2,2,4,4-tetramethyl-1,3-cyclobutanediol, based on the total moles of 2,2,4,4-tetramethyl-1,3-cyclobutanediol residues.

13. The polyester blend according to claim 12, wherein said residues of 2,2,4,4-tetramethyl-1,3-cyclobutanediol comprise about 80 to 100 mole percent cis 2,2,4,4-tetramethyl-1,3-cyclobutanediol and about 20 to 0 mole percent trans 2,2,4,4-tetramethyl-1,3-cyclobutanediol, based on the total moles of 2,2,4,4-tetramethyl-1,3-cyclobutanediol.

14. The polyester blend according to claim 1 wherein said second polyester comprises phosphorus atoms.

15. The polyester blend according to claim 14, wherein said phosphorus atoms are added to said second polyester as at least one alkyl phosphate ester, aryl phosphate ester, mixed alkyl aryl phosphate ester, diphosphite, salt of phosphoric acid, phosphine oxide, mixed alkyl aryl phosphite, reaction products thereof, or mixtures thereof.

16. A shaped article comprising the polyester blend of claim 1.

17. The shaped article of claim 16 which is formed by extrusion, calendering, thermoforming, blow-molding, extrusion blow-molding, injection stretch blow-molding, injection molding, injection blow-molding, compression molding, profile extrusion, cast extrusion, melt-spinning, drafting, tentering, or blowing.

18. The shaped article of claim 17 which is a sheet, film, fiber, tube, preform, container, or bottle.

19. The shaped article of claim 17 which is a component of a home appliance.

20. A polyester blend comprising:
A. about 10 to 90 weight percent of a first polyester comprising:
i. diacid residues comprising about 60 to about 80 mole percent, based on the total first polyester diacid residues, of the residues of terephthalic acid and about 20 to about 40 mole percent of the residues of isophthalic acid; and
ii. diol residues comprising about 70 to 100 mole percent, based on the total first polyester diol residues, of the residues of 1,4-cyclohexanedimethanol and about 0 to about 30 mole percent of the residues of ethylene glycol;
and
B. about 10 to 90 weight percent of a second polyester comprising:
i. diacid residues comprising about 90 to 100 mole percent, based on the total second polyester diacid residues, of the residues of terephthalic acid; and
ii. diol residues comprising about 20 to about 50 mole percent, based on the total second polyester diol residues, of the residues of 2,2,4,4-tetramethyl-1,3-cyclobutanediol and about 50 to about 80 mole percent of the residues of 1,4-cyclohexanedimethanol;
wherein said second polyester has an inherent viscosity of about 0.50 to about 0.75 dL/g and a glass transition temperature of about 100 to about 130° C. and said blend exhibits a single glass transition temperature by differential scanning calorimetry.

21. The polyester blend according to claim 20, wherein said residues of 2,2,4,4-tetramethyl-1,3-cyclobutanediol comprise about 60 to 100 mole percent cis 2,2,4,4-tetramethyl-1,3-cyclobutanediol and about 40 to 0 mole percent trans 2,2,4,4-tetramethyl-1,3-cyclobutanediol, based on the total moles of 2,2,4,4-tetramethyl-1,3-cyclobutanediol.

22. The polyester blend of claim 20 which comprises about 40 to about 60 weight percent of said first polyester and about 40 to about 60 mole percent of said second polyester.

23. A shaped article comprising said polyester blend of claim 20.

24. The shaped article of claim 23 wherein said polyester blend comprises about 1 to about 50 weight percent recovered scrap from a shaped article forming process.

25. A process for the preparation of a polyester blend, comprising melt blending:
A. about 5 to about 95 weight percent of at least one first polyester comprising:
i. diacid residues comprising about 50 to 100 mole percent, based on the total first polyester diacid residues, of the residues of terephthalic acid and 0 to about 50 mole percent of the residues of isophthalic acid; and
ii. diol residues comprising about 70 to 100 mole percent, based on the total first polyester diol residues, of the residues of 1,4-cyclohexanedimethanol and about 0 to about 30 mole percent of the residues of ethylene glycol;
and
B. about 5 to about 95 weight percent of at least one second polyester comprising:
i. diacid residues comprising about 80 to 100 mole percent, based on the total second polyester diacid residues, of the residues of terephthalic acid; and
ii. diol residues comprising about 10 to about 50 mole percent, based on the total second polyester diol residues, of the residues of 2,2,4,4-tetramethyl-1,3-cyclobutanediol and about 50 to about 90 mole percent of the residues of 1,4-cyclohexanedimethanol;
wherein said blend exhibits a single glass transition temperature by differential scanning calorimetry.
